(19) United States
(12) Patent Application Publication
(10) Pub. No.: US 2022/0136888 A1
(43) Pub. Date: May 5, 2022

(54) DISPLACEMENT AND WEIGHT ASSOCIATION APPARATUS

(71) Applicant: NEC Corporation, Minato-ku, Tokyo (JP)

(72) Inventor: Jun TAKADA, Tokyo (JP)

(73) Assignee: NEC Corporation, Minato-ku, Tokyo (JP)

(21) Appl. No.: 17/431,515

(22) PCT Filed: Dec. 17, 2019
(86) PCT No.: PCT/JP2019/049461

§ 371 Date: Aug. 17, 2021

(30) Foreign Application Priority Data
Feb. 26, 2019 (JP) 2019-033183

(51) Int. Cl. G01G 19/03; G01M 99/00; E01D 22/00

(52) U.S. Cl. CPC G01G 19/03; E01D 22/00; G01M 99/00

(57) ABSTRACT

A displacement and weight association apparatus includes a measuring unit configured to measure a displacement amount generated on a structure by a weight of a vehicle traveling on the structure; an aggregating unit configured to obtain a distribution of the measured displacement amount; an extracting unit configured to extract a displacement amount corresponding to a car from the distribution; and an associating unit configured to associate the extracted displacement amount with a weight of the car.

### TECHNICAL FIELD

The present invention relates to a displacement and weight association apparatus, a displacement and weight association method, and a recording medium.

### BACKGROUND ART

When a vehicle passes a structure such as a bridge, a load is applied to the structure and the structure is displaced. Various techniques for obtaining a correspondence between such displacement of a structure and a vehicle weight (the weight of a vehicle) have been proposed.

For example, Patent Document 1 describes a first technique and a second technique as shown below.

In the first technique, first, displacement amounts generated on a traveling road are detected from an image of vehicles traveling on the traveling road. Next, the detected displacement amounts are aggregated, and a histogram of the displacement amounts (a distribution of the displacement amounts) is generated. Next, the weight of a vehicle of vehicle type whose volume of traffic is the most on the traveling road is associated with the mode of the above histogram. As the weight of a vehicle type of the heaviest traffic on the traveling road, one that previously determined and stored in advance is used.

Further, in the second technique, from an image of vehicles traveling on a traveling road, a specific vehicle is recognized, and a displacement generated on the traveling road due to the specific vehicle is detected. As a specific vehicle, a vehicle of vehicle type whose weight does not vary much due to a shipment or the like is desirable. Next, the weight of the specific vehicle is associated with the detected displacement amount.
Patent Document 1: Japanese Unexamined Patent Application Publication No. JP-A 2018-059896

However, there is no guarantee that a vehicle of vehicle type whose volume of traffic is the most on a traveling road is a vehicle of vehicle type whose load variation due to a shipment or the like is small. Therefore, in the abovementioned first technique, in a case where a vehicle of vehicle type whose volume of traffic is the most on a traveling road is a vehicle of vehicle type whose load variation due to a shipment or the like is large, the accuracy of associating displacement with a vehicle weight decreases. On the other hand, in the abovementioned second technique, since a vehicle of vehicle type whose weight does not vary much due to a shipment or the like is set as a specific vehicle, it is possible to accurately associate displacement with a vehicle weight. However, for that purpose, the second technique requires recognition of a specific vehicle from an image of vehicles traveling on a traveling road, which is not convenient.

### SUMMARY

An object of the present invention is to provide a displacement and weight association apparatus that solves the abovementioned problem; a problem that it is difficult to conveniently and accurately obtain a correspondence between displacement of a structure and a causal vehicle weight.

A displacement and weight association apparatus according to an aspect of the present invention includes: a measuring unit configured to measure a displacement amount generated on a structure by a weight of a vehicle traveling on the structure; an aggregating unit configured to obtain a distribution of the measured displacement amount; an extracting unit configured to extract a displacement amount corresponding to a car from the distribution; and an associating unit configured to associate the extracted displacement amount with a weight of the car.

Further, a displacement and weight association method according to another aspect of the present invention includes: measuring a displacement amount generated on a structure by a weight of a vehicle traveling on the structure; obtaining a distribution of the measured displacement amount; extracting a displacement amount corresponding to a car from the distribution; and associating the extracted displacement amount with a weight of the car.

Further, on a non-transitory computer-readable recording medium according to another aspect of the present invention, a program is recorded. The program includes instructions for causing a computer to execute: a process of measuring a displacement amount generated on a structure by a weight of a vehicle traveling on the structure; a process of obtaining a distribution of the measured displacement amount; a process of extracting a displacement amount corresponding to a car from the distribution; and a process of associating the extracted displacement amount with a weight of the car.

With the configurations as described above, the present invention makes it possible to conveniently and accurately obtain a correspondence between displacement of a structure due to passage of a vehicle and a causal vehicle weight.

### BRIEF DESCRIPTION OF DRAWINGS

FIG. 1 is a view showing a configuration example of a diagnostic apparatus according to a first example embodiment of the present invention;

FIG. 2 is a block diagram showing an example of a configuration of a computer in the diagnostic apparatus according to the first example embodiment of the present invention;

FIG. 3 is a view showing an example of a displacement and vehicle weight association result in the diagnostic apparatus according to the first example embodiment of the present invention;

FIG. 4 is a view showing a content example of a diagnosis result database in the diagnostic apparatus according to the first example embodiment of the present invention;

FIG. 5 is a flowchart showing an example of a process executed by the computer in the diagnostic apparatus according to the first example embodiment of the present invention;

FIG. 6 is a view showing a configuration example of a displacement and weight association unit in the diagnostic apparatus according to the first example embodiment of the present invention;

FIG. 7 is a schematic diagram showing an example of temporal change in deflection amount of a surface of a structure measured by the displacement and weight association unit in the diagnostic apparatus according to the first example embodiment of the present invention;

FIG. 8 is a view showing an example of a list of deflection amount peak values measured by the displacement and weight association unit in the diagnostic apparatus according to the first example embodiment of the present invention;

FIG. 9 is a view showing an example of a list in which deflection amount peak values are arranged in ascending order, showing a distribution generated by the displacement and weight association unit in the diagnostic apparatus according to the first example embodiment of the present invention;

FIG. 10 is a view showing an example of a histogram showing a distribution generated by the displacement and weight association unit in the diagnostic apparatus according to the first example embodiment of the present invention; and

FIG. 11 is a block diagram of a displacement and weight association apparatus according to a second example embodiment of the present invention.

### EXAMPLE EMBODIMENTS

Next, example embodiments of the present invention will be described in detail with reference to the drawings.

### First Example Embodiment

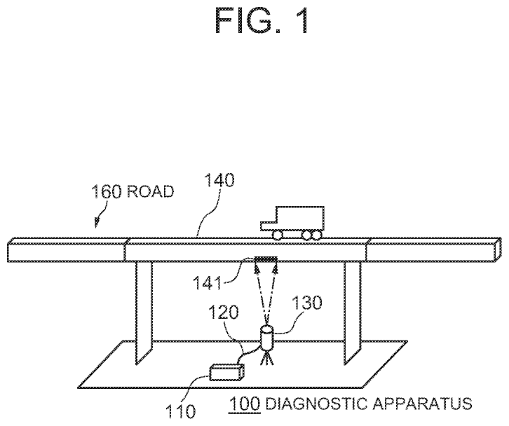

FIG. 1 is a view showing a configuration example of a diagnostic apparatus 100 according to a first example embodiment of the present invention. Referring to FIG. 1, the diagnostic apparatus 100 includes a computer 110 and a camera 130 connected to the computer 110 via a cable 120.

The camera 130 is an image capture device that captures a region 141 existing on the surface of a structure 140 to be diagnosed at a predetermined frame rate. In this example embodiment, the structure 140 is a bridge where a road 160 such as an expressway crosses over a river or the like. In this example embodiment, the region 141 is part of a floor deck that is a diagnosis spot of the bridge. However, the structure 140 is not limited to a bridge. The structure 140 may be an elevated structure of an expressway or a railway, or the like. The size of the region 141 is, for example, several tens of centimeters square. The camera 130 is attached to a pan head (not shown) on a tripod (not shown) so that the shooting direction of the camera can be fixed in any direction. The camera 130 may be, for example, a high-speed camera that includes a CCD (Charge-Coupled Device) image sensor or a CMOS (Complementary MOS) image sensor having pixel capacity of about several million pixels. Moreover, the camera 130 may be a black and white camera, or may be an infrared camera or a color camera. Moreover, the camera 130 may include a GPS receiver that measures the position of the camera, or may include an orientation sensor and an acceleration sensor that measure the shooting direction of the camera.

The computer 110 is configured to acquire a time-series image of the structure 140 captured by the camera 130 via the cable 120. Moreover, the computer 110 is configured to measure the displacement amount of the structure 140 based on the acquired time-series image. In this example embodiment, a displacement amount to be measured is a deflection amount. Moreover, the computer 110 is configured to detect a correspondence between the deflection amount of the structure 140 and a vehicle weight based on the measured displacement amounts. Moreover, the computer 110 is configured to determine the soundness of the structure 140 based on the detected correspondence between the deflection amount and the vehicle weight, and output the result of the determination.

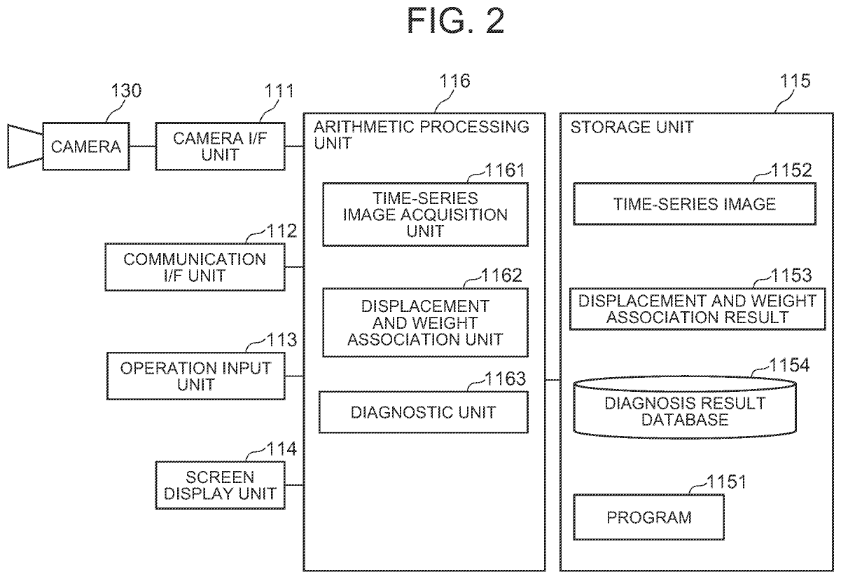

FIG. 2 is a block diagram showing an example of a configuration of the computer 110. Referring to FIG. 2, the computer 110 includes a camera I/F (interface) unit 111, a communication I/F unit 112, an operation input unit 113, a screen display unit 114, a storage unit 115, and an arithmetic processing unit 116.

The camera I/F unit 111 is connected to the camera 130 through the cable 120, and is configured to perform transmission and reception of data with the camera 130 and the arithmetic processing unit 116. The communication I/F unit 112 is composed of a data communication circuit, and is configured to perform data communication with an external device (not shown) by wired or wireless communication. The operation input unit 113 is composed of an operation input device such as a keyboard and a mouse, and is configured to detect an operator's operation and output to the arithmetic processing unit 116. The screen display unit 114 is composed of a screen display device such as an LCD (Liquid Crystal Display), and is configured to display various information such as a menu screen on a screen in response to an instruction from the arithmetic processing unit 116.

The storage unit 115 is composed of a storage device such as a hard disk and a memory, and is configured to store processing information and a program 1151 that are necessary for various processes in the arithmetic processing unit 116. The program 1151 is a program that is loaded to and executed by the arithmetic processing unit 116 to realize various processing units, and is previously loaded from an external device or a recording medium, which are not shown, via a data input/output function such as the communication I/F unit 112 and stored into the storage unit 115. Major processing information stored in the storage unit 115 are a time-series image 1152, a displacement and weight association result 1153, and a diagnosis result database 1154.

The time-series image 1152 is a time-series image captured by the camera 130. This time-series image 1152 may be a plurality of frame images composing a moving image of the region 141 of the structure 140 captured by the camera 130.

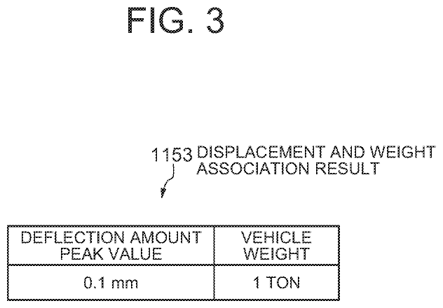

The displacement and weight association result 1153 is data in which a deflection amount peak value of the region 141 of the structure 140 is associated with the weight of a vehicle. FIG. 3 shows an example of the displacement and weight association result 1153. In the displacement and weight association result 1153 of this example, a deflection amount peak value of 0.1 mm is associated with a vehicle weight of 1 ton. In other words, this shows that when a load of 1 ton is applied to around the region 141 of the structure 140, a deflection amount of 0.1 mm at the maximum is generated.

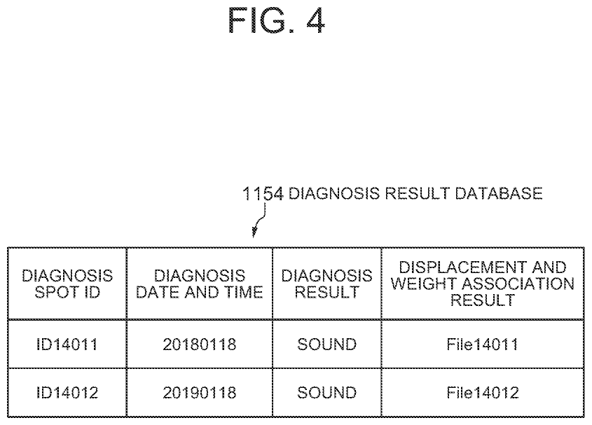

The diagnosis result database 1154 is configured so that information relating to a diagnosis result is stored. FIG. 4 shows an example of data stored in the diagnosis result database 1154. The diagnosis result database 1154 of this example is composed of a plurality of entries, and a diagnosis spot ID, a diagnosis date and time, a diagnosis result, and a displacement and weight association result are recorded in each entry. For example, an entry of the first row shows that the result of diagnosis of the region 141 of the structure 140 specified by a diagnosis spot ID of ID14011 on Feb. 18, 2018 indicates soundness and the displacement and weight association result 1153 obtained in the diagnosis is stored in a file of File 14011.

The arithmetic processing unit 116 includes a processor such as an MPU and its peripheral circuit, and is configured to load the program 1151 from the storage unit 115 and execute to make the above hardware and the program 1151 cooperate and realize various processing units. Major processing units realized by the arithmetic processing unit 116 are a time-series image acquisition unit 1161, a displacement and weight association unit 1162, and a diagnostic unit 1163.

The time-series image acquisition unit 1161 is configured to acquire a time-series image captured by the camera 130 through the camera IN unit 111, and add the acquired time-series image to the time-series image 1152 of the storage unit 115 and store.

The displacement and weight association unit 1162 is configured to measure a deflection amount generated on the structure 140 by the weight of a vehicle traveling on the structure 140 based on the time-series image 1152 stored in the storage unit 115. Moreover, the displacement and weight association unit 1162 is configured to obtain the distribution of the measured deflection amounts. Moreover, the displacement and weight association unit 1162 is configured to extract a displacement amount corresponding to a car from the above distribution. Moreover, the displacement and weight association unit 1162 is configured to associate the extracted displacement amount with the weight of the car, and store the result as the displacement and weight association result 1153 into the storage unit 115. The details of the displacement and weight association unit 1162 will be described later.

The diagnostic unit 1163 is configured to perform a deterioration diagnosis of the structure 140 based on the displacement and weight association result 1153 stored in the storage unit 115. For example, the diagnostic unit 1163 retrieves a deflection amount and a vehicle weight from the displacement and weight association result 1153, compares an allowable deflection amount previously stored in association with the retrieved vehicle weight with the retrieved deflection amount, and determines that there is a deterioration in the region 141 of the structure 140 when the deflection amount is more than the allowable deflection amount, whereas determines that the region 141 is sound when not. However, the method of deterioration diagnosis by the diagnostic unit 1163 is not limited to the above. The deterioration diagnosis may be performed by a method different from the above based on the displacement and weight association result 1153. Moreover, in addition to the diagnosis based on the displacement and weight association result 1153 or instead of such a diagnosis, the deterioration diagnosis may be performed by another method. For example, the diagnostic unit 1163 may analyze the time-series image 1152 stored in the storage unit 115 or a time-series image separately acquired by using the camera 130 to measure vibrations of the surface of the structure 140, and estimate an internal deterioration status such as a crack, exfoliation, and a cavity from the pattern of the vibrations. Moreover, the diagnostic unit 1163 is configured to store information relating to the estimated diagnosis result into the diagnosis result database 1154. Moreover, the diagnostic unit 1163 is configured to display the estimated diagnosis result on the screen display unit 114, and/or transmit the diagnosis result to an external terminal through the communication I/F unit 112.

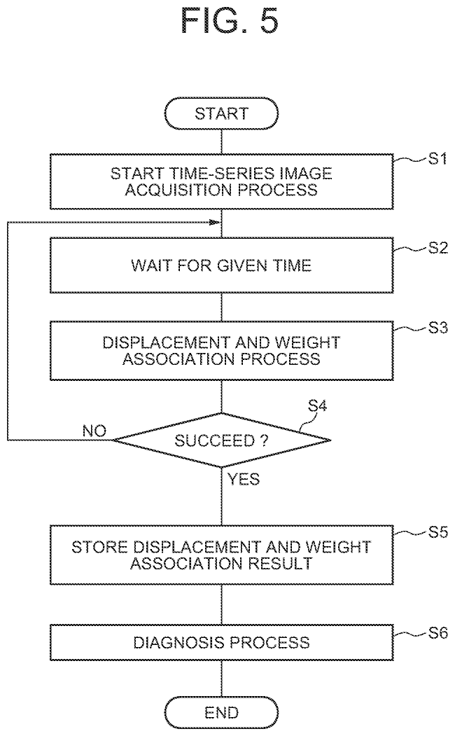

FIG. 5 is a flowchart showing an example of an operation of the diagnostic apparatus 100. Below, with reference to the drawings, an operation of the diagnostic apparatus 100 when performing a deterioration diagnosis of the structure 140 will be described.

When an operator installs measurement devices such as the computer 110 and the camera 130 at sites and inputs an activation instruction through the operation input unit 113 in order to perform a deterioration diagnosis of the structure 140, a process shown in FIG. 5 is started by the computer 110.

First, the time-series image acquisition unit 1161 starts operating. The time-series image acquisition unit 1161 acquires a time-series image of the region 141 of the structure 140 captured by the camera 130, and sequentially stores as the time-series image 1152 into the storage unit 115 (step S1). Hereinafter, the time when the time-series image acquisition unit 1161 starts acquisition of a time-series image will be referred to as time Ts. The time-series image acquisition unit 1161 continuously executes the above process until the process shown in FIG. 5 ends.

Next, the displacement and weight association unit 1162 waits for a given time (step S2). During the wait for the given time, the latest time-series image is sequentially acquired by the time-series image acquisition unit 1161, and accumulated into the storage unit 115. After the wait for the given time, the displacement and weight association unit 1162 retrieves all of the accumulated time-series image 1152 from the storage unit 115, and executes a displacement and weight association process based on the retrieved images (step S3). Next, when succeeding in the displacement and weight association process (step S4, YES), the displacement and weight association unit 1162 stores the displacement and association result 1153 into the storage unit 115 (step S5). On the other hand, for example, in a case where the accumulation amount of the time-series image 1152 is small, or in a case where there is no traveling vehicle, the displacement and weight association unit 1162 may fail in the displacement and weight association process. In the case of failing in the displacement and weight association process (step S4, NO), the displacement and weight association unit 1162 returns to step S2 to wait for the given time again, and thereafter, retrieves all of the accumulated time-series image 1152 from the storage unit 115, and executes the displacement and weight association process based on the retrieved images (step S3). Thus, the displacement and weight association unit 1162 extends the period of a time-series image to be processed until the displacement and weight association process succeeds.

When the displacement and weight association process succeeds and the displacement and weight association result 1153 is generated, the diagnostic unit 1163 retrieves the displacement and weight association result 1153 from the storage unit 115, performs a deterioration diagnosis of the structure 140 based on the displacement and weight association result 1153, and stores and outputs a diagnosis result (step S6). Then, the diagnostic unit 1163 ends the process shown in FIG. 5.

Next, a configuration example of the displacement and weight association unit 1162 will be described.

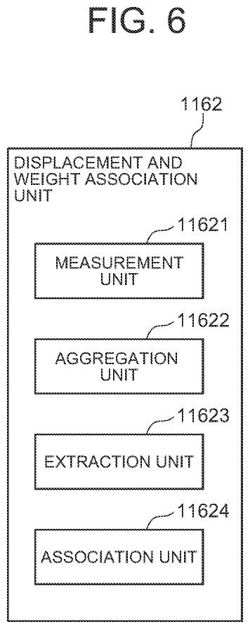

FIG. 6 is a block diagram showing an example of the displacement and weight association unit 1162. Referring to FIG. 6, the displacement and weight association unit 1162 includes a measurement unit 11621, an aggregation unit 11622, an extraction unit 11623, and an association unit 11624.

The measurement unit 11621 is configured to measure a displacement amount generated on the structure 140 due to the weight of a vehicle traveling on the structure 140 based on the time-series image 1152. To be specific, the measurement unit 11621 retrieves all of the time-series image 1152 stored in the storage unit 115, and measures a temporal change in deflection amount of the surface of the structure 140 from each of the time-series images. For example, in the case of capturing an image of the floor deck of a bridge from below with a camera, a capture length L between the camera and the floor deck is shortened by a deflection amount δ generated on the floor deck of the bridge due to the weight of a vehicle. Therefore, the captured image is magnified around the optical axis of the camera, and apparent displacement δi due to deflection occurs. When a capture length is L, displacement is δi, a deflection amount is δ, a distance from the camera optical axis of a displacement calculation position is x, and a focal length of the camera is f, there is a relation of δᵢ=xf{1/(L−δ)−1/L}. Therefore, by detecting the displacement δi for each frame image by a digital image correlation method or the like, the deflection amount of the surface of the structure 140 for each frame image can be calculated from the above equation. The capture length L can be measured in advance by, for example, a laser range finder, the distance x can be obtained from the displacement calculation position of the image and the camera optical axis, and f is known for each imaging device. Moreover, since even minute vibrations are picked up as deflection to be measured, general measures may be added such as a low-pass filter or, when a peak value is small (less than a threshold value), excluding from the count.

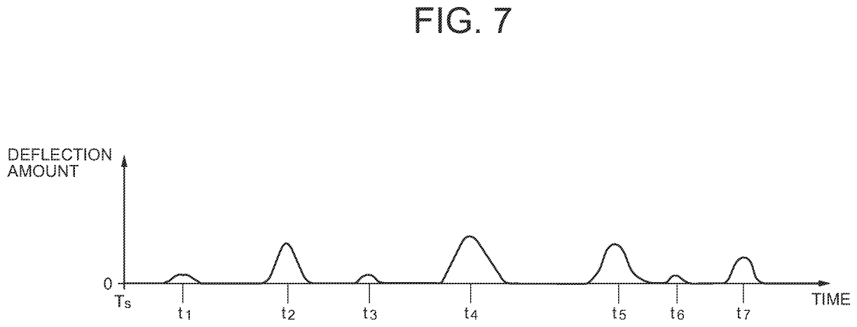

FIG. 7 is a schematic view showing an example of a temporal change in deflection amount of the surface of the structure 140 measured from the time-series image 1152. The vertical axis takes a deflection amount, and the horizontal axis takes time.

Further, the measurement unit 11621 detects a deflection amount peak value by detecting the maximal value of the measured temporal change in deflection amount. For example, in the example shown in FIG. 7, the measurement unit 11621 detects deflection amount peak values at times t₁, t₂, t₃, t₄, t₅, t₆, and t₇. Then, the measurement unit 11621 creates a list of the detected deflection amount peak values.

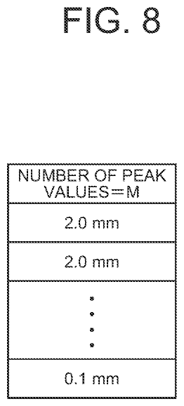

FIG. 8 shows an example of a list of deflection amount peak values. This example shows that the number of measured peak values is M in total and the peak values are 2.0 mm, 2.0 mm, . . . , 0.1 mm.

The measurement unit 11621 determines whether or not the number M of peak values written in the created list exceeds a preset lower limit number and, if the number M does not exceed the lower limit number, determines that the association fails. The lower limit number is previously determined based on desired association accuracy between displacement and a vehicle weight. In the case of failing in the association, the displacement/weight association unit 1162 executes step S2 of FIG. 5 again. If the number M exceeds the lower limit number, the measurement unit 11621 sends the created list to the aggregation unit 11622.

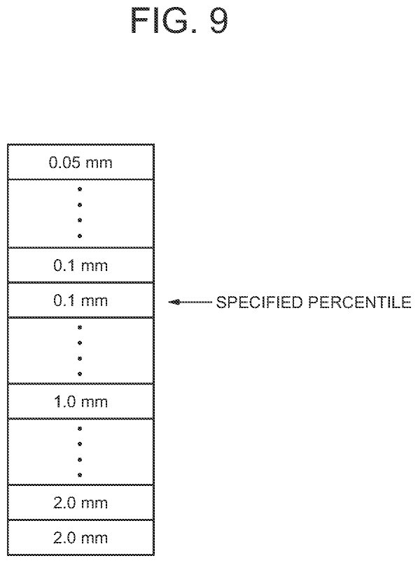

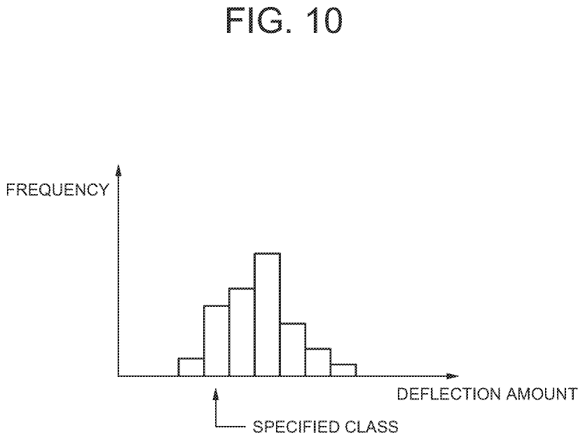

The aggregation unit 11622 is configured to generate a distribution of the deflection amount peak values written in the list sent from the measurement unit 11621. For example, as shown in FIG. 9, the aggregation unit 11622 generates, as the distribution, a list in which the deflection amount peak values are arranged, for example, in ascending order. Alternatively, as shown in FIG. 10, the aggregation unit 11622 divides deflection amount peak values into classes and generates a histogram in which the appearance frequency for each class is graphed.

The extraction unit 11623 is configured to extract a deflection amount corresponding to a car from the distribution generated by the aggregation unit 11622. Since a car belongs to a small vehicle, a deflection amount caused thereby tends to be smaller than a deflection amount caused by a large vehicle. Therefore, a deflection amount corresponding to a car tends to appear on the lower side of the distribution. Thus, the extraction unit 11623 extracts a displacement amount corresponding to a car from a lower displacement amount distribution in the distribution. For example, in the extraction unit 11623, information representing the position of a distribution corresponding to a car is preset and stored. The information indicating the position of the distribution can be expressed by, for example, a percentile, a class, or the like. To be specific, a possible method is to pinpoint a lower-side position of a distribution, such as a 3^{rd} percentile, or to specify a desired range on a lower side of a distribution, such as a 2^{nd} to 3^{rd} percentile or a bottom 3^{rd} percentile. The same applies to class, and a possible method is to specify a class such as a second class from the bottom, or to specify a range such as a second to third class from the bottom or a range such as two classes from the bottom. In a case where percentile is used, the extraction unit 11623 extracts a deflection amount at a specified percentile from the top of the list in which deflection amount peak values are arranged in ascending order as shown in FIG. 9 or the average value of deflection amounts within a range of the specified percentile, as a deflection amount corresponding to a car. In a case where class is used, the extraction unit 11623 extracts a deflection amount belonging to a specified class in the histogram as shown in FIG. 10 or the average value of deflection amounts within a range of the specified class, as a deflection amount corresponding to a car.

In this example embodiment, a car represents regular cars with classification numbers of 3, 30 to 39, and 300 to 399, and compact cars with classification numbers of 5, 7, 50 to 59, 500 to 599, 70 to 79, and 700 to 799. However, the definition of a car is not limited to the above. For example, a car may represent the above regular cars and the above compact cars plus subcompacts. Alternatively, a car may represent any one of the above compact cars, the above regular cars, and subcompacts.

Further, a position occupied by a car in the distribution may differ depending on the type of the road 160, location and time. In order to deal with such a situation, the following configuration is possible. First, information indicating positions in the distribution corresponding to car for the type of the road 160, location, and time are stored in advance in the storage unit 115, respectively. Next, the extraction unit 11623 receives input of the type of the road 160 to be diagnosed, location and time from the operator via the operation input unit 113 or the like, and acquires information stored in the storage unit in association with the inputted road type, location and time (information indicating a position occupied by car in the distribution). Alternatively, instead of storing the information as described above in advance, the extraction unit 11623 may acquire information indicating a position occupied by car in the distribution from the operation input unit 113 or the like each time.

The association unit 11624 is configured to associate the displacement amount extracted by the extraction unit 11623 with the weight of a car previously given and stored. The weight of a car previously given is specified in advance based on the average vehicle weight of a car, the average number of passengers, the average shipment, and so on, and stored.

The above is an example of the displacement and weight association unit 1162.

As described above, according to this example embodiment, it is possible to accurately obtain a correspondence between displacement of the structure 140 due to passage of a vehicle and a causal vehicle weight. The reason is that a car, on which variation of a load due to a shipment or the like is small, is focused on.

Further, according to this example embodiment, it is possible to conveniently obtain a correspondence between displacement of the structure 140 due to passage of a vehicle and a causal vehicle weight. The reason is that a displacement amount corresponding to a car is extracted from a distribution of measured displacement amounts and there is no need to identify whether or not a vehicle passing a structure is a car by image recognition or the like.

In this example embodiment, various additions and changes are possible. For example, in this example embodiment, a deflection amount of the structure 140 is associated with a vehicle weight. However, displacement of the structure 140 to be associated with a vehicle weight is not limited to a deflection amount. For example, in a case where the structure 140 has a crack, the width of the crack increases when a load is applied to the structure 140. Therefore, the width of a crack of the structure may be associated with a vehicle weight.

Further, in this example embodiment, displacement of the structure 140 is detected based on an image of structure 140 captured by a camera. However, the sensor detecting displacement of the structure 140 is not limited to the camera. For example, a laser range finder may be used to detect displacement such as a deflection amount of the structure 140. Moreover, for example, a strain gauge may be used to detect displacement such as a deflection amount or a crack width of the structure 140.

### Second Example Embodiment

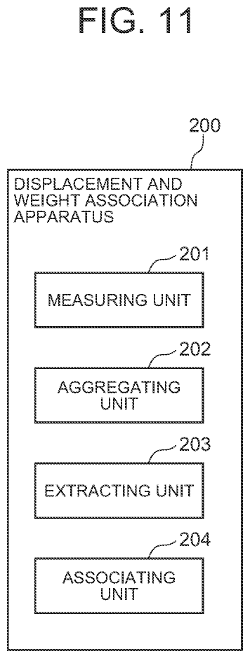

Next, a second example embodiment of the present invention will be described with reference to FIG. 11. FIG. 11 is a block diagram of a displacement and weight association apparatus according to this example embodiment. In this example embodiment, the overview of the displacement and weight association apparatus according to the present invention will be described.

Referring to FIG. 11, a displacement and weight association apparatus 200 according to this example embodiment includes a measuring unit 201, an aggregating unit 202, an extracting unit 203, and an associating unit 204.

The measuring unit 201 is configured to measure a displacement amount generated on a structure due to the weight of a vehicle traveling on the structure. The measuring unit 201 can be configured, for example, in the same manner as the measurement unit 11621 shown in FIG. 6, but is not limited thereto.

The aggregating unit 202 is configured to obtain a distribution of the displacement amounts measured by the measuring unit 201. The aggregating unit 202 can be configured, for example, in the same manner as the aggregation unit 11622 shown in FIG. 6, but is not limited thereto.

The extracting unit 203 is configured to extract a displacement amount corresponding to a car from the distribution generated by the aggregating unit 202. The extracting unit 203 can be configured, for example, in the same manner as the extraction unit 11623 shown in FIG. 6, but is not limited thereto.

The associating unit 204 is configured to associate the displacement amount extracted by the extracting unit 203 with the weight of a car. The associating unit 204 can be configured, for example, in the same manner as the association unit 11624 shown in FIG. 6, but is not limited thereto.

The displacement and weight association apparatus 200 thus configured operates in the following manner. First, the measuring unit 201 measures a displacement amount generated on a structure due to the weight of a vehicle traveling on the structure. Next, the aggregating unit 202 obtains a distribution of the displacement amounts measured by the measuring unit 201. Next, the extracting unit 203 extracts a displacement amount corresponding to a car from the distribution generated by the aggregating unit 202. Next, the associating unit 204 associates the displacement amount extracted by the extracting unit 203 with the weight of a car.

With the above configuration and operation, this example embodiment makes it possible to conveniently and accurately obtain a correspondence between displacement of a structure due to passage of a vehicle and a causal vehicle weight. The reason is that a car, on which variation of a load due to a shipment or the like is small, is focused on, a displacement amount corresponding to a car is extracted from a distribution of measured displacement amounts, and the extracted displacement amount is associated with the weight of a car.

Although the present invention has been described above with reference to the example embodiments, the present invention is not limited to the above example embodiments. The configurations and details of the present invention can be changed in various manners that can be understood by one skilled in the art within the scope of the present invention.

The present invention is based upon and claims the benefit of priority from Japanese patent application No. 2019-033183, filed on Feb. 26, 2019, the disclosure of which is incorporated herein in its entirety by reference.

The present invention can be utilized, for example, in the case of associating the weight of a vehicle passing a structure such as a bridge with displacement such as a deflection amount of the structure.

The whole or part of the example embodiments disclosed above can be described as, but not limited to, the following supplementary notes.

### [Supplementary Note 1]

A displacement and weight association apparatus comprising:

a measuring unit configured to measure a displacement amount generated on a structure by a weight of a vehicle traveling on the structure;

an aggregating unit configured to obtain a distribution of the measured displacement amount;

an extracting unit configured to extract a displacement amount corresponding to a car from the distribution; and

an associating unit configured to associate the extracted displacement amount with a weight of the car.

### [Supplementary Note 2]

The displacement and weight association apparatus according to Supplementary Note 1, wherein the extracting unit is configured to extract a displacement amount corresponding to the car from a lower displacement amount distribution in the distribution of the displacement amount.

### [Supplementary Note 3]

The displacement and weight association apparatus according to Supplementary Note 1 or 2, wherein the measuring unit is configured to detect a temporal change in displacement of the structure by analyzing a time-series image obtained by capturing a surface of the structure and detect a maximal value of the temporal change in displacement.

### [Supplementary Note 4]

The displacement and weight association apparatus according to any of Supplementary Notes 1 to 3, further comprising a diagnosing unit configured to perform a deterioration diagnosis of the structure based on a result of associating the displacement amount with the weight of the car.

### [Supplementary Note 5]

A displacement and weight association method comprising:

measuring a displacement amount generated on a structure by a weight of a vehicle traveling on the structure;

obtaining a distribution of the measured displacement amount;

extracting a displacement amount corresponding to a car from the distribution; and

associating the extracted displacement amount with a weight of the car.

### [Supplementary Note 6]

A non-transitory computer-readable recording medium on which a program is recorded, the program comprising instructions for causing a computer to execute:

a process of measuring a displacement amount generated on a structure by a weight of a vehicle traveling on the structure;

a process of obtaining a distribution of the measured displacement amount;

a process of extracting a displacement amount corresponding to a car from the distribution; and

a process of associating the extracted displacement amount with a weight of the car.

### DESCRIPTION OF NUMERALS

100 diagnostic apparatus
110 computer
111 camera I/F unit
112 communication IN unit
113 operation input unit
114 screen display unit
115 storage unit
116 arithmetic processing unit
120 cable
130 camera
140 structure
141 region
160 road
200 displacement and weight association apparatus
201 measuring unit
202 aggregation unit
203 extracting unit
204 associating unit

What is claimed is:

1. A displacement and weight association apparatus comprising:
a memory containing program instructions; and
a processor coupled to the memory,
wherein the processor is configured to execute the program instructions to:
measure a displacement amount generated on a structure by a weight of a vehicle traveling on the structure;
obtain a distribution of the measured displacement amount;
extract a displacement amount corresponding to a car from the distribution; and
associate the extracted displacement amount with a weight of the car.

2. The displacement and weight association apparatus according to claim 1, wherein in the extraction, a displacement amount corresponding to the car is extracted from a lower displacement amount distribution in the distribution of the displacement amount.

3. The displacement and weight association apparatus according to claim 1, wherein in the measurement, a temporal change in displacement of the structure is detected by analyzing a time-series image obtained by capturing a surface of the structure and a maximal value of the temporal change in displacement is detected.

4. The displacement and weight association apparatus according to claim 1, wherein the processor is further configured to perform a deterioration diagnosis of the structure based on a result of associating the displacement amount with the weight of the car.

5. A displacement and weight association method comprising:
measuring a displacement amount generated on a structure by a weight of a vehicle traveling on the structure;
obtaining a distribution of the measured displacement amount;
extracting a displacement amount corresponding to a car from the distribution; and
associating the extracted displacement amount with a weight of the car.

6. A non-transitory computer-readable recording medium on which a program is recorded, the program comprising instructions for causing a computer to execute:
a process of measuring a displacement amount generated on a structure by a weight of a vehicle traveling on the structure;
a process of obtaining a distribution of the measured displacement amount;
a process of extracting a displacement amount corresponding to a car from the distribution; and
a process of associating the extracted displacement amount with a weight of the car.

7. The displacement and weight association apparatus according to claim 1, wherein:
the processor is further configured to acquire information showing a position of a distribution of the car; and
in the extraction, a displacement amount corresponding to the car is extracted from the acquired information and the distribution.

8. The displacement and weight association apparatus according to claim 7, wherein in the acquisition, information showing a position of a distribution corresponding to the car is previously stored for each structure type, location and time, the structure type, location and time are input from an operation input unit, and the information stored in association with the inputted structure type, location and time is acquired.

9. The displacement and weight association apparatus according to claim 7, wherein in the acquisition, the information is acquired from an operation input unit.
